(19) United States
(12) Patent Application Publication
(10) Pub. No.: US 2012/0042307 A1
(43) Pub. Date: Feb. 16, 2012

(54) SYSTEM AND METHOD FOR CREATING MEMORY INTERFACE OF COMPUTING DEVICE

(75) Inventor: WEI SHAO, Shenzhen (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/105,902

(22) Filed: May 12, 2011

(30) Foreign Application Priority Data
Aug. 12, 2010 (CN) 201010251954.1

(51) Int. Cl. G06F 9/44

(52) U.S. Cl. 717/168

(57) ABSTRACT

In a system and method for creating a memory interface of a computing device, the computing device includes a basic input output system (BIOS), a system management unit, a memory, a baseboard management controller (BMC), and a storage system. When the computing device boots up normally, the system specifies a memory mapping space in the memory by mapping a physical address of the BMC to a physical address of the memory using the BIOS. The method sets an interface specification of the memory according to a firmware standard of the BMC, and creates a memory interface in the memory mapping space according to the interface specification. The system controls the system management unit to read upgrade data from the storage system, and writes the upgrade data into the BMC to update a firmware of the BMC through the memory interface.

### BACKGROUND

1. Technical Field

Embodiments of the present disclosure relate to storage systems and methods, and particularly to a system and method for creating a memory interface of a computing device.

2. Description of Related Art

Computing devices, such as servers, may be installed with one or more baseboard management controllers (BMC). The BMC may include firmware that can control the BMC to communicate with other components (e.g., a memory or a CPU) of a computing device. The BMC may read or write data to from the memory, and transfer the data between the BMC and the memory through a system bus of the computing device. However, the data transfer speed is too slow using the system bus when mass data need to be changed between the BMC and the memory.

### BRIEF DESCRIPTION OF THE DRAWINGS

FIG. 1 is a block diagram of one embodiment of a computing device including a memory interface management system.

FIG. 2 is a block diagram of one embodiment of function modules of the system included in the computing device of FIG. 1.

FIG. 3 is a flowchart of one embodiment of a method for creating a memory mapping space of a computing device using the system of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

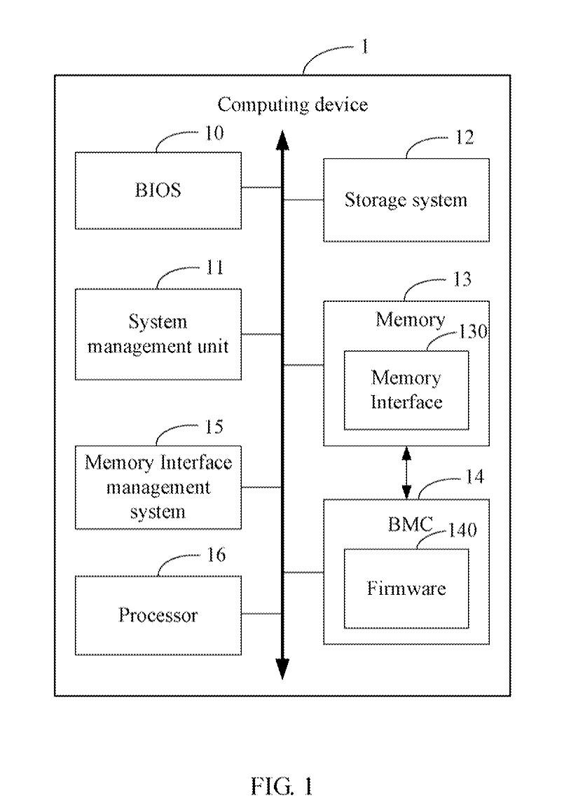

FIG. 1 is a block diagram of one embodiment of a computing device 1 including a memory interface management system 15. In the embodiment, the computing device 1 may be a computer or a server, and further includes a basic input output system (BIOS) 10, a system management unit 11, a storage system 12, a memory 13, a baseboard management controller (BMC) 14, and at least one processor 16. The memory 13 includes a memory interface 130 that communicates with the BMC 14, and the BMC 14 is installed with a firmware 140 that controls the BMC14 to communicate with other components such as the storage system 12 or the memory 13, for example. Each of the components 11-16 communicates with each other through a system bus of the computing device 1. It should be understood that FIG. 1 illustrates only one example of the computing device 1, and may include more or fewer components than illustrated, or a different configuration of the various components in other embodiments.

The system management unit 11 reads upgrade data from the storage system 12 through the system bus of the computing device 1, and updates the firmware 140 of the BMC 14 according to the upgrade data. In the embodiment, the system management unit 11 may read the upgrade data from the storage system 12 using a direct memory access (DMA) channel.

In one embodiment, the storage system 12 may be an internal storage system, such as a random access memory (RAM) for temporary storage of information, and/or a read only memory (ROM) for permanent storage of information. In some embodiments, the storage system 12 may also be an external storage system, such as an external hard disk, a storage card, or a data storage medium.

The memory interface management system 15 includes a plurality of function modules that may comprise one or more programs are stored in the storage system 12 and executed by the processor 16 to provide functions for implementing the function modules. The memory interface management system 15 is operable to create a memory interface 130 in a memory space of the memory 13, and update the firmware 140 of the BMC 14 with the upgrade data stored in the storage system 12 through the memory interface 130.

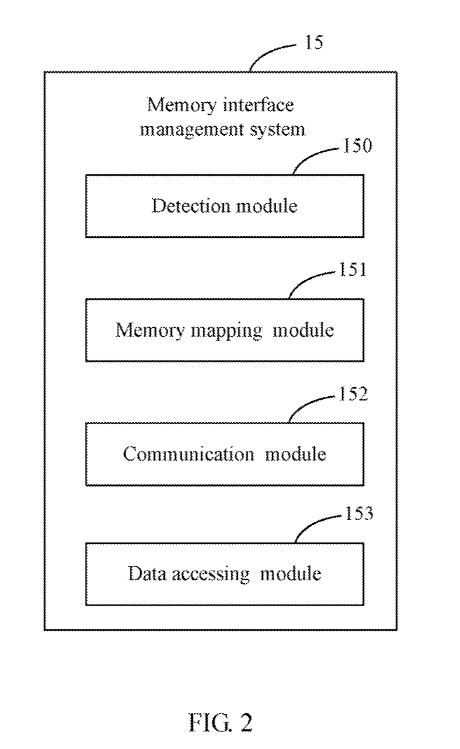

FIG. 2 is a block diagram of one embodiment of function modules of the memory interface management system 15 included in the computing device 1. In the embodiment, the memory interface management system 15 includes a detection module 150, a memory mapping module 151, a communication module 152, and a data accessing module 153. The modules 150-153 may comprise computerized code in the form of one or more programs that are stored in the storage system 12. The computerized code includes instructions that are executed by the at least one processor 16 to provide functions for implementing the modules. In general, the word “module,” as used herein, refers to logic embodied in hardware or firmware, or to a collection of software instructions, written in a program language. In one embodiment, the program language may be Java or C. One or more software instructions in the modules may be embedded in firmware, such as an EPROM. The modules described herein may be implemented as either software and/or hardware modules and may be stored in any type of computer-readable medium or other storage system.

The detection module 150 is operable to determine whether the computing device 1 boots up normally, and perform a reboot procedure when the computing device 1 does not boot up normally. In the embodiment, if the computing device 1 is able to start the operating system (OS) when the computing device 1 is powered on, the detection module 150 determines that the computing device 1 boots up normally. If the computing device 1 does not boot up normally, the detection module 150 may display error information on a display of the computing device 1 and perform a reboot procedure.

The memory mapping module 151 is operable to specify a memory mapping space in the memory 13 by mapping a physical address of the BMC 14 to a physical address of the memory 13 using the BIOS 10, when the computing device 1 boots up normally. In the embodiment, the physical address is a data access address that denotes data transfer between the memory 13 and the BMC 14. The BMC 14 is a peripheral component interconnect (PCI) bus device, and includes a data configuration area for storing the firmware 140. The data configuration area has a physical address and can be accessed by the system management unit 11. For example, if the physical address of the BMC 14 is “0x00000001”, the memory mapping module 151 may create a memory space in the address “0x00000001” of the memory 13 as the memory interface 130.

The communication module 152 is operable to set an interface specification of the memory 13 according to a firmware standard of the BMC 14, and create a memory interface 130 in the memory mapping space according to the interface specification. In the embodiment, the firmware standard of the BMC 14 complies with an intelligent platform management interface (IPMI) specification, such as a data transfer protocol for transferring data between the memory 13 and the BMC 14.

The data accessing module 153 is operable to control the system management unit 11 to read upgrade data from the storage system 12 and to temporarily store the upgrade data into the memory 13, and write the upgrade data into the BMC 14 to update the firmware 140 through the memory interface 130.

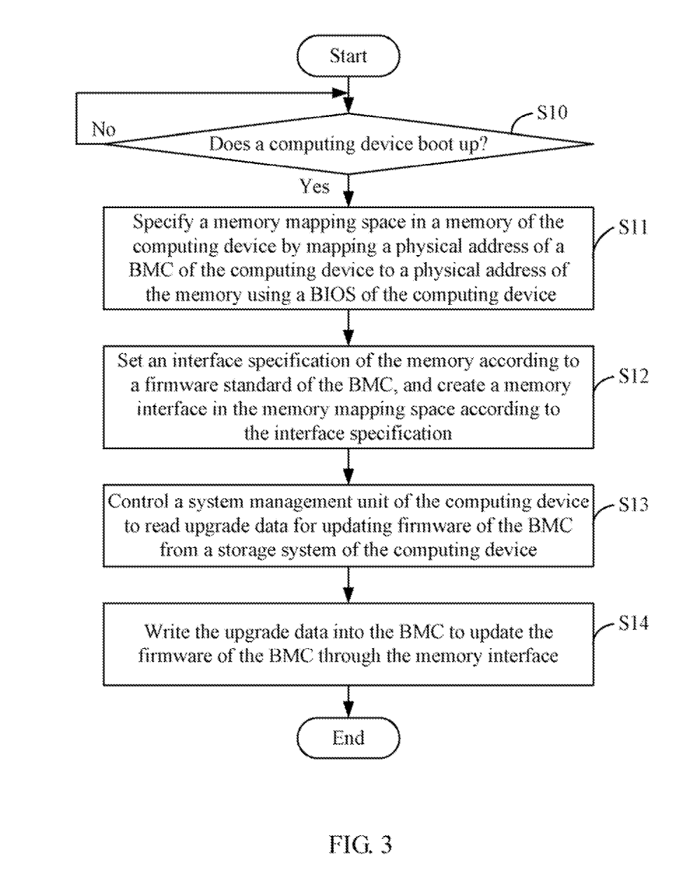

FIG. 3 is a flowchart of one embodiment of a method for creating a memory interface of a computing device using the system 15 of FIG. 1. Depending on the embodiment, additional blocks may be added, others removed, and the ordering of the blocks may be changed.

In block S10, the detection module 150 determines whether the computing device 1 boots up normally. If the computing device 1 does not boot up normally, the detection module 150 performs a reboot procedure and may display error information on a display of the computing device 1. If the computing device 1 boots up normally, block S11 is implemented.

In block S11, the memory mapping module 151 specifies a memory mapping space in the memory 13 by mapping a physical address of the BMC 14 to a physical address of the memory 13 using the BIOS 10 of the computing device 1. In the embodiment, the physical address is a data access address that denotes data transfer between the memory 13 and the BMC 14. For example, if the physical address of the BMC 14 is “0x00000001”, the memory mapping module 151 may create a memory space in the address “0x00000001” of the memory 13 as the memory interface 130.

In block S12, the communication module 152 sets an interface specification of the memory 13 according to a firmware standard of the BMC 14, and creates a memory interface 130 in the memory mapping space of the memory 13 according to the interface specification. In the embodiment, the firmware standard of the BMC 14 complies to an intelligent platform management interface (IPMI) standard, such as a data transfer protocol for transferring data between the memory 13 and the BMC 14.

In block S13, the data accessing module 153 controls the system management unit 11 to read upgrade data from the storage system 12, and temporarily stores the upgrade data into the memory 13. In block S14, the data accessing module 153 controls the system management unit 11 to write the upgrade data into the BMC 14 to update the firmware 140 through the memory interface. In the embodiment, the system management unit 11 may read the upgrade data from the storage system 12 using a direct memory access (DMA) channel.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, comprising:
a basic input output system (BIOS), a system management unit, a memory, a baseboard management controller (BMC), a storage system, and at least one processor; and
one or more programs stored in the storage system and executable by the at least one processor, the one or more programs comprising:
a memory mapping module operable to specify a memory mapping space in a memory by mapping a physical address of the BMC to a physical address of the memory using the BIOS;
a communication module operable to set an interface specification of the memory according to a firmware standard of the BMC, and create a memory interface in the memory mapping space according to the interface specification; and
a data accessing module operable to control the system management unit to read upgrade data from the storage system and temporarily store the upgrade data into the memory, and write the upgrade data into the BMC to update a firmware of the BMC through the memory interface.

2. The computing device according to claim 1, wherein the one or more programs further comprise a detection module operable to detect whether the computing device boots up normally, and perform a reboot procedure and display error information on a display of the computing device when the computing device does not boot up normally.

3. The computing device according to claim 1, wherein the system management unit reads the upgrade data from the storage system using a direct memory access (DMA) channel.

4. The computing device according to claim 1, wherein the BMC is a peripheral component interconnect (PCI) bus device, and comprises a data configuration area for storing the firmware that is accessed by the system management unit through the physical address of the BMC.

5. The computing device according to claim 1, wherein the firmware standard of the BMC complies with an intelligent platform management interface (IPMI) specification.

6. A computerized method for creating a memory interface of a computing device, the computing device comprising a basic input output system (BIOS), a system management unit, a memory, a baseboard management controller (BMC) and a storage system, the method comprising:
specifying a memory mapping space in the memory by mapping a physical address of the BMC to a physical address of the memory using the BIOS;
setting an interface specification of the memory according to a firmware standard of the BMC;
creating a memory interface in the memory mapping space according to the interface specification; and
controlling the system management unit to read upgrade data from the storage system and temporarily store the upgrade data into the memory, and writing the upgrade data into the BMC to update a firmware of the BMC through the memory interface.

7. The method according to claim 6, further comprising:
detecting whether the computing device boots up normally; and
performing a reboot procedure and displaying error information on a display of the computing device, if the computing device does not boot up normally.

8. The method according to claim 6, wherein the system management unit reads the upgrade data from the storage system using a direct memory access (DMA) channel.

9. The method according to claim 6, wherein the BMC is a peripheral component interconnect (PCI) bus device, and comprises a data configuration area for storing the firmware that is accessed by the system management unit through the physical address of the BMC.

10. The method according to claim 6, wherein the firmware standard of the BMC complies with an intelligent platform management interface (IPMI) specification.

11. A non-transitory storage medium having stored thereon instructions that, when executed by at least one processor of a computing device that comprises a basic input output system (BIOS), a system management unit, a memory, a baseboard management controller (BMC) and a storage system, causes the computing device to perform a method for creating a memory interface of the computing device, the method comprising:
specifying a memory mapping space in the memory by mapping a physical address of the BMC to a physical address of the memory using the BIOS;
setting an interface specification of the memory according to a firmware standard of the BMC;
creating a memory interface in the memory mapping space according to the interface specification; and
controlling the system management unit to read upgrade data from the storage system and temporarily store the upgrade data into the memory, and writing the upgrade data into the BMC to update a firmware of the BMC through the memory interface.

12. The storage medium according to claim 11, wherein the method further comprises:
detecting whether the computing device boots up normally; and
performing a reboot procedure and displaying error information on a display of the computing device if the computing device does not boot up normally.

13. The storage medium according to claim 11, wherein the system management unit reads the upgrade data from the storage system using a direct memory access (DMA) channel.

14. The storage medium according to claim 11, wherein the BMC is a peripheral component interconnect (PCI) bus device, and comprises a data configuration area for storing the firmware that is accessed by the system management unit through the physical address of the BMC.

15. The storage medium according to claim 11, wherein the firmware standard of the BMC complies with an intelligent platform management interface (IPMI) specification.
